(19) United States
(12) Patent Application Publication
(10) Pub. No.: US 2026/0310493 A1
(43) Pub. Date: Oct. 8, 2026

(54) Modular Serverless Pipeline Execution Framework

(71) Applicant: ServiceNow, Inc., Santa Clara, CA (US)

(72) Inventors: David Joshua Wiener, Beit Shemesh (IL); Shimon Gabai, San Diego, CA (US); Vincent Seguin, Rancho Santa Fe, CA (US); Magaly Drant, Rancho Santa Fe, CA (US); Devin Lee Stallings, Oak Park, IL (US); Scott Marshall, San Diego, CA (US)

(21) Appl. No.: 19/098,023

(22) Filed: Apr. 2, 2025

(51) Int. Cl. G06F 9/48

(52) U.S. Cl. CPC G06F 9/4881

(57) ABSTRACT

A method includes detecting a trigger event and obtaining pipeline configuration information based on detecting the trigger event. The method includes identifying a first function based on the pipeline configuration information. Based on the first function, the method includes generating a pipeline execution plan including a sequence of tasks and one or more second functions. The method includes executing the one or more second function based on the sequence of tasks.

### TECHNICAL FIELD

This disclosure relates to a pipeline execution framework.

### BACKGROUND

Software development involves various stages of building, testing, and deploying applications. Various software tools, sometimes referred to as “pipeline execution frameworks,” may be used to automate these stages and streamline the software development lifecycle. A pipeline execution framework typically uses a monolithic infrastructure. A monolithic infrastructure is characterized by a single, large, and interconnected system that performs the pipeline stages. The monolithic infrastructure has several drawbacks, such as being cumbersome to use, requiring significant manual configuration and maintenance, and being unable to adapt to the dynamic and diverse needs of modern software development. As software projects increase in complexity and scale, there is a growing demand for a more adaptable and scalable pipeline execution framework.

### SUMMARY

One implementation of the disclosure provides a computer-implemented method of using a serverless pipeline execution framework. The method includes detecting a trigger event and obtaining pipeline configuration information based on detecting the trigger event. The method includes identifying a first function based on the pipeline configuration information. Based on the first function, the method includes generating a pipeline execution plan including a sequence of tasks and one or more second functions. The method includes executing the one or more second function based on the sequence of tasks.

Implementations of the disclosure may include one or more of the following optional features. In some implementations, the pipeline configuration information includes at least one of pipeline task definitions, input parameters, sequence execution order, or result reporting preferences. Executing the one or more second functions may include at least one of provisioning instances, deploying applications, scaling application deployments, managing persistent volumes, or executing cluster-wide operations. In some examples, the method further includes generating execution results based on executing the one or more second functions. In these examples, the method may further include sending the execution results to a user device. Here, the execution results, when received by the user device, are configured to cause the user device to display the execution results.

In some implementations, the first function includes a code script that executes at a distributed computing system. Each second function may include a respective code script that executes at a distributed computing system. In some examples, obtaining the pipeline configuration information includes obtaining the pipeline configuration information from a remote computing instance in communication with a distributed computing system. In these examples, generating the pipeline execution plan includes authenticating the remote computing instance. Executing the one or more second function may include executing two or more second functions in parallel. In some implementations, executing the one or more second function includes executing an initial second function, determining that the initial second function has completed execution, and executing a subsequent second function based on determining that the initial second function has completed execution. The method may further include selecting a respective second function of the one or more second functions for each respective task of the sequence of tasks. Here, executing the one or more second function includes executing the respective second function of the one or more second functions for the respective task.

Another implementation of the disclosure provides a system that includes data processing hardware and memory hardware storing instructions that when executed on the data processing hardware causes the data processing hardware to perform operations. The operations include detecting a trigger event and obtaining pipeline configuration information based on detecting the trigger event. The operations include identifying a first function based on the pipeline configuration information. Based on the first function, the operations include generating a pipeline execution plan including a sequence of tasks and one or more second functions. The operations include executing the one or more second function based on the sequence of tasks.

Implementations of the disclosure may include one or more of the following optional features. In some implementations, the pipeline configuration information includes at least one of pipeline task definitions, input parameters, sequence execution order, or result reporting preferences. Executing the one or more second functions may include at least one of provisioning instances, deploying applications, scaling application deployments, managing persistent volumes, or executing cluster-wide operations. In some examples, the operations further include generating execution results based on executing the one or more second functions. In these examples, the operations further include sending execution results to a user device. The execution results, when received by the user device, are configured to cause the user device to display the execution results. The first function may include a code script that executes at a distributed computing system. In some implementations, each second function includes a respective code script that executes at a distributed computing system.

Another implementation of the disclosure provides a computer-readable medium having instructions that, when executed by data processing hardware, causes the data processing hardware to perform operations. The operations include detecting a trigger event and obtaining pipeline configuration information based on detecting the trigger event. The operations include identifying a first function based on the pipeline configuration information. Based on the first function, the operations include generating a pipeline execution plan including a sequence of tasks and one or more second functions. The operations include executing the one or more second function based on the sequence of tasks.

The details of one or more implementations of the disclosure are set forth in the accompanying drawings and the description below. Other implementations, features, and advantages will be apparent from the description and drawings, and from the claims.

### DESCRIPTION OF DRAWINGS

FIG. 1 is a schematic view of an example system using a serverless pipeline execution framework.

FIG. 2 is a schematic view of an example serverless pipeline execution framework.

FIG. 3 is a schematic view of example pipeline configuration information.

FIG. 4 is a flowchart of an example arrangement of operations for a computer-implemented method of using a serverless pipeline execution framework.

FIG. 5 is a schematic view of an example computing device that may be used to implement the systems and methods described herein.

Like reference symbols in the various drawings indicate like elements.

### DETAILED DESCRIPTION

A pipeline execution framework is a software tool that automates various stages of building, testing, and deploying applications. These stages are often referred to as pipeline tasks, which may include, for example, compiling source code, running unit tests, performing code analysis, packaging artifacts, deploying to target environments, and monitoring performance. The pipeline execution framework aims to streamline the software development lifecycle by reducing manual intervention, human errors, and development time. However, many pipeline execution frameworks use a monolithic infrastructure, which is a single, large, and interconnected system that performs all the pipeline tasks. For example, a monolithic infrastructure may include a central server that hosts the pipeline execution framework software, a database that stores the pipeline configuration and state, and a network that connects the server to the various agents or nodes that execute the pipeline tasks. The monolithic infrastructure has several drawbacks, such as being cumbersome and inflexible, requiring significant manual configuration and maintenance, and being unable to adapt to the dynamic and diverse needs of modern software development. For instance, a monolithic infrastructure may not be able to handle sudden spikes or drops in the demand for pipeline resources, may not be able to support different types of pipeline tasks or environments, and may not be able to provide high availability and fault tolerance. Moreover, a traditional continuous integration and deployment (CI/CD) system, which is a subset of a pipeline execution framework that focuses on integrating and delivering code changes, also suffers from these limitations. That is, the traditional CI/CD system lacks the flexibility and scalability needed to efficiently manage complex, distributed computing environments.

Accordingly, implementations herein are directed towards a serverless pipeline framework. The serverless pipeline framework obtains pipeline configuration based on detecting a trigger event. The trigger event may include various events, such as requests, database changes, or messages from other services. The serverless pipeline framework identifies a first function based on the pipeline configuration information. The first function may be a serverless function. A serverless function is a piece of code that runs on a distributed computing system that allocates resources on demand and charges only for the execution time. The serverless pipeline framework generates a pipeline execution plan based on the first function. The pipeline execution plan includes a sequence of tasks and one or more second functions. Each of the second functions may also be a serverless function. In some examples, the first function may invoke the one or more second functions thereby creating a chain of actions. The serverless pipeline framework executes the one or more second functions based on the sequence of tasks.

Advantageously, the serverless pipeline framework does not rely on a monolithic infrastructure, but instead uses a distributed and decentralized architecture (e.g., distributed computing system) that leverages serverless computing. Serverless computing abstracts away the underlying infrastructure and allows the execution of code or functions on demand, without requiring the provisioning or management of servers. Serverless computing enables the dynamic allocation and scaling of resources based on the workload, and only charges for the actual usage of resources, rather than for the reserved capacity. Other advantages over a monolithic infrastructure include being more flexible and scalable, requiring less configuration and maintenance, and being more cost-effective and efficient. For example, the serverless pipeline framework may dynamically create and destroy pipeline tasks as functions, support different types of pipeline tasks or environments, and provide high availability and fault tolerance. In some instances, the serverless pipeline framework reduces the overhead and latency of the pipeline execution to provide faster feedback and continuous delivery.

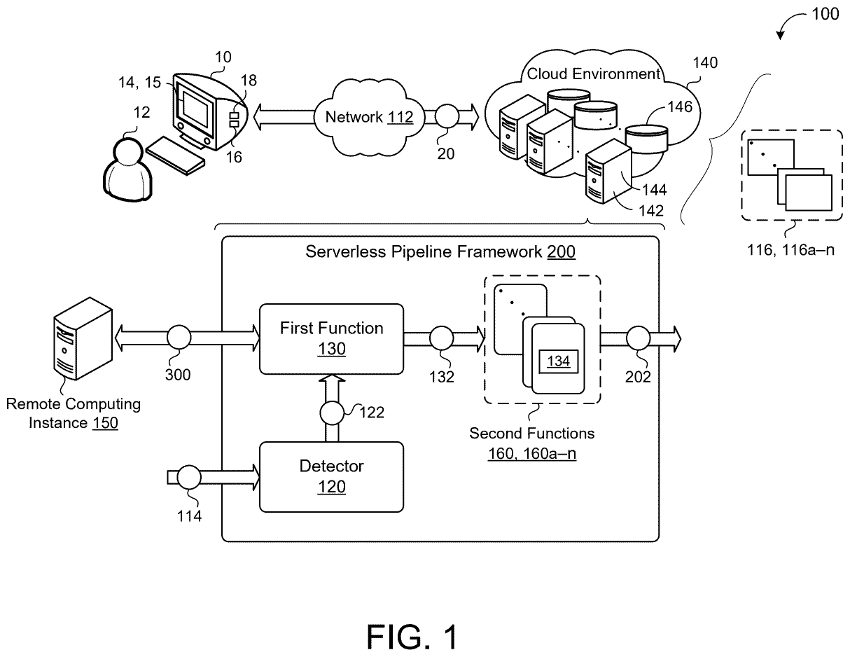

Referring to FIG. 1, in some implementations, a system 100 includes a remote system 140 in communication with one or more user devices 10 each associated with a respective user 12 via a network 112, such as the Internet, a local area network (LAN), a wide area network (WAN), a cellular network, or a wireless network. The remote system (i.e., distributed computing system) 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 is configured to communicate with the user device 10 via, for example, the network 112. Additionally, the remote system 140 may execute a plurality of resource pools 116, 116a-n whereby each resource pool 116 may include one or more computing instances. A resource pool 116 is a collection of computing resources, such as CPU, memory, and storage, that are managed as a single entity. The resource pool 116 allows for efficient allocation and management of computing resources across various applications. Each computing instance within a resource pool 116 represents a virtualized environment that may run applications independently, providing scalability and flexibility to handle varying workloads.

The user device(s) 10 may correspond to any computing device, such as a desktop workstation, a laptop workstation, or a mobile device (i.e., a smart phone). Each user device 10 includes computing resources 18 (e.g., data processing hardware) and/or storage resources 16 (e.g., memory hardware). The data processing hardware 18 executes a graphical user interface (GUI) 15 for display on a screen 14 in communication with the data processing hardware 18. The GUI 15 may be provided by a web browser, a web application, a native application, or a hybrid application running on the user device 10.

The remote system 140 executes a serverless pipeline framework 200 that the user device 10 communicates with via the network 112. The serverless pipeline framework 200 is configured to deploy and execute pipelines without the need for dedicated servers or infrastructure (e.g., in a serverless manner), leveraging cloud-based services. A pipeline is a sequence of tasks 134 or functions that work together to perform a specific operation or process on data or resources. For example, a pipeline may include tasks such as building code, running tests, or deploying software instances to a production environment. Each task 134 in the pipeline may be executed in a predefined sequence, ensuring that the output of one task 134 serves as the input for the next task 134, thereby streamlining the overall process. The serverless pipeline framework 200 utilizes serverless computing services (i.e., a first function 130 and one or more second functions 160) to execute the tasks 134 or functions in the pipeline without requiring dedicated servers or infrastructure. The first function 130 and the one or more second functions 160 are serverless because each function is managed by the provider of the remote system 140, automatically scales with demand, and does not require the user 12 to manage the underlying servers.

Serverless computing services are cloud-based services that provide on-demand and scalable execution of code or functions based on events or requests, and charge only for actual execution time and resources used. Unlike traditional server functions, which require dedicated servers to be running continuously, serverless functions are event-driven and only run in response to specific triggers. This means that serverless functions do not incur costs or consume computing resources on behalf of the serverless pipeline framework 200 when they are not running, whereas server functions require ongoing maintenance and incur costs and consume computing resources even when idle. As such, serverless functions abstract away the underlying infrastructure, allowing developers to focus solely on writing code. As a result, serverless functions lead to optimization benefits such as automatic scaling, where the cloud provider automatically adjusts the number of function instances based on demand, ensuring efficient resource utilization. Additionally, serverless functions offer cost benefits by eliminating the need for over-provisioning and reducing operational overhead, as users 12 are billed only for the compute time that the serverless functions consume. For example, a serverless function might be triggered to process a batch of data whenever new data is uploaded to a cloud storage service, ensuring that resources are used only when necessary.

The serverless pipeline framework 200 includes a detector 120 that detects whether a trigger event 114 occurs or not. A trigger event 114 is an event or condition that initiates the execution of a pipeline or a part of a pipeline. Trigger events 114 may include time-based triggers, such as a predetermined interval, or event-based triggers, such as the arrival of new data. For instance, an event may be set to occur every 30 minutes, prompting the detector 120 to initiate the pipeline execution at regular intervals of 30 minutes. Alternatively, a trigger event 114 may be the completion of a previous task, receiving a specific message, or a change in the state of a resource, such as a file being uploaded to a cloud storage service. Based on detecting the trigger event 114, the detector 120 generates a notification 122 that informs the first (i.e., primary) function 130 that the trigger event 114 has occurred. The first function 130 is a serverless function that is responsible for orchestrating the execution of the pipeline or part of the pipeline.

Based on receiving the notification 122, the first function 130 obtains pipeline configuration information 300. For example, if the trigger event 114 occurs every 20 minutes, the first function 130 obtains the pipeline configuration information 300 every 20 minutes. In some implementations, the first function 130 obtains the pipeline configuration information 300 from a remote computing instance 150, which communicates with the serverless pipeline framework 200 via the network 112. The remote computing instance 150 may be a specialized computing entity responsible for managing and storing the pipeline configuration information 300. As such, the remote computing instance may be a scheduling instance that stores and provides the pipeline configuration information 300 based on a predefined schedule or a manual override. The serverless pipeline framework 200 only fetches and uses the pipeline configuration information 300 to execute the pipeline, the serverless pipeline framework 200 does not generate or edit the pipeline configuration information 300. The remote computing instance 150 may be part of the remote system 140 or separate from the remote system 140. Simply put, the remote computing instance 150 ensures that the pipeline configuration information 300 is accurately maintained and readily available for the serverless pipeline framework 200 to fetch and use during pipeline execution. In some configurations, the remote computing instance 150 may be the user device 10.

The pipeline configuration information 300, which is controlled by and stored at the remote computing instance 150, includes detailed parameters and settings for each task 134 in the pipeline. The parameters and settings may include execution time, resource allocation, resource requirements, and dependencies. For instance, execution time specifies how long a task 134 should run, while resource allocation determines the amount and type of resources assigned to a task 134. Resource requirements outline the necessary resources for task 134 completion, and dependencies indicate the order in which tasks 134 should be executed based on interrelations among the tasks 134. Additionally, the serverless pipeline framework 200 fetches the pipeline configuration information 300 from the remote computing instance 150 when the trigger event 114 occurs. The scheduling instance may accommodate manual adjustments to the resource allocation schedule to address urgent needs or exceptions, ensuring flexibility and responsiveness in pipeline execution. For example, if there is an urgent need to deploy a critical update, the scheduling instance may override the predefined schedule to allocate more resources to the deployment tasks. The scheduling instance may define a resource allocation schedule for different pools of resources that are used for different functions, such as building code, running tests, or building databases. The scheduling instance may also allow for manual adjustments of the resource allocation schedule to address immediate needs or exceptions.

The pipeline configuration information 300 specifies the parameters and settings for the pipeline, such as pipeline task definitions, input and output parameters, sequence execution order, and result reporting preferences. For example, the task definitions provide a detailed description of the requirements of each task 134, while input and output parameters define the data that tasks 134 will receive and produce. Sequence execution order determines the order in which tasks 134 are executed, and result reporting preferences specify how the outcomes of tasks 134 should be reported. For example, the pipeline configuration information 300 may indicate that the pipeline includes multiple tasks 134, each dedicated to a specific function. These functions may include finding running instances, starting or stopping instances, draining instances, setting capacity, or terminating instances.

The pipeline configuration information 300 may also indicate the order of execution of the tasks 134, such as executing tasks 134 sequentially or in parallel, depending on the dependencies and requirements of the pipeline. For example, tasks 134 that depend on the output of previous tasks 134 will be executed sequentially, while independent tasks 134 may be executed in parallel to save time and resources. The pipeline configuration information 300 may also indicate the input and output data for each task 134, such as the resource pool name, the instance name, the instance status, the instance capacity, or the instance load. The pipeline configuration information 300 may also indicate the resource allocation for each task 134, such as the number of instances, the type of instances, the location of instances, or the cost of instances. The pipeline configuration information 300 may also indicate the error handling for each task 134, such as the retry mechanism, the logging mechanism, the recovery mechanism, or the notification mechanism. For instance, if a task 134 fails, the retry mechanism may attempt to rerun the task 134 a specified number of times, while the logging mechanism records the error details for further analysis. The recovery mechanism ensures that the pipeline can continue running despite errors, and the notification mechanism alerts relevant personnel about the issue.

Based on the obtained pipeline configuration information 300, the first function 130 generates a pipeline execution plan 132 that defines how to execute the pipeline using the serverless pipeline framework 200. Generating the pipeline execution plan 132 may involve analyzing the pipeline configuration information 300, determining the sequence of tasks 134 to be executed, and allocating necessary resources to complete the pipeline. In some implementations, the first function 130 authenticates the remote computing instance 150 before generating the pipeline execution plan 132 based on the pipeline configuration information. For instance, the first function 130 may verify the credentials of the remote computing instance 150 and ensure that the remote computing instance 150 has permissions to access the remote system 140. The first function 130 may be a primary function that includes a code script that executes at the remote system 140 to orchestrate the one or more second functions 160. The pipeline execution plan 132 includes a sequence of tasks 134 each representing a step or a stage in the pipeline that performs a specific operation or action on the resources or data involved in the pipeline. For example, a task 134 may be to find the running instances in a resource pool 116, to start or stop an instance in a resource pool 116, to drain an instance from a resource pool 116, to set the capacity of a resource pool 116, or to terminate an instance from a resource pool 116.

Additionally or alternatively, the pipeline execution plan 132 may include one or more second (i.e., secondary) functions 160, 160a-n. The second functions 160 are configured to handle specific tasks 134 of the pipeline execution plan 132. Each second function 160 represents a serverless function that is invoked by the first function 130 to execute a task 134. Similar to the first function 130, each second function 160 may include a respective code script that executes at the remote system 140. The pipeline execution plan 132 specifies the parameters and settings for each task 134 and each second function 160, such as the input and output data, the resource allocation, the error handling, or the result reporting.

For each respective task 134 of the sequence of tasks 134, the serverless pipeline framework 200 selects a respective second function 160 to execute the task 134, ensuring that the appropriate second function 160 performs each task 134. This means that for every task 134 defined in the pipeline execution plan 132, the serverless pipeline framework 200 identifies and assigns specific second function 160 that is best suited to handle that task 134. Each second function 160 is designed to perform a particular type of operation, such as starting an instance, setting capacity, or terminating an instance. By matching tasks 134 with the most appropriate second functions 160, the framework ensures that each task is executed efficiently and correctly. The execution of the one or more second functions 160 involves invoking the respective second function 160 for each task 134, which then carries out the task according to the parameters and settings defined in the pipeline execution plan 132. The pipeline execution plan 132 also specifies the order or logic of execution of the tasks 134 and the second functions 160, such as executing tasks sequentially or in parallel, depending on the requirements of the pipeline.

Thereafter, the first function 130 invokes the one or more second functions 160 to perform the sequence of tasks 134. Each second function 160 is a serverless function that runs on a serverless computing platform. Moreover, each section function 160 is configured to perform a particular type of task 134, ensuring that the tasks 134 are executed efficiently and correctly. That is, each second function 160 receives the input data and the resource allocation for the corresponding task 134 from the pipeline execution plan 132, and executes the task 134 using the serverless pipeline framework 200. The serverless pipeline framework 200 provides the necessary infrastructure and resources dynamically, allowing each second function 160 to focus solely on executing its designated task 134.

For example, a second function 160 may use an API to access resources, such as container orchestration clusters, auto-scaling groups, or virtual machine instances, and perform the operations or actions on the resources, such as finding, starting, stopping, draining, setting capacity, or terminating nodes. The one or more second functions 160 execute to perform the sequence of tasks 134, each tailored to handle specific operations efficiently. Executing the one or more second functions 160 involves executing the respective second function 160 for each respective task 134 in the sequence of tasks 134, as defined in the pipeline execution plan 132. This means that each second function 160 is specifically designed to handle a particular task 134, ensuring that the task is executed efficiently and correctly. The sequence of tasks 134 is determined by the pipeline execution plan 132, which outlines the order in which tasks should be performed. For example, if the pipeline execution plan 132 specifies that a task 134 to start an instance must be followed by a task 134 to set the capacity of the instance, the second function 160 responsible for starting the instance will execute first, followed by the second function 160 responsible for setting the capacity. This sequential execution ensures that each task 134 is completed in the correct order, maintaining the integrity and efficiency of the pipeline. Additionally, the pipeline execution plan 132 may specify that certain tasks 134 can be executed in parallel if they are independent of each other, allowing for faster completion of the pipeline. Executing two or more second functions 160 in parallel means that multiple tasks 134 are performed simultaneously rather than sequentially. For instance, if there are tasks 134 that do not depend on one another, such as starting different instances or updating different resources, these tasks 134 may be assigned to separate second functions 160 and executed concurrently.

Each second function 160 receives the necessary input data and resource allocation from the pipeline execution plan 132, executes the task 134, handles any errors, logs the results, and returns the output data and status to the first function 130. The first function 130 then monitors the execution and determines whether to proceed to the next task 134 or to terminate the pipeline execution based on the results. Each second function 160 also handles the errors and logs the results for the corresponding task 134 and returns the output data and the status of the task 134 to the first function 130. The first function 130 monitors the execution of the tasks 134 and the second functions 160 and determines whether to proceed to the next task 134 or to terminate the pipeline execution based on the pipeline execution plan 132. For instance, after an initial second function 160 has executed, the first function 130 may determine whether the initial second function has completed execution or not. Based on determining that the initial second function 160 has completed execution, the first function 130 may execute a subsequent second function 160.

Executing the one or more second function 160 may include at least one of provisioning instances, deploying applications, scaling application deployments, managing persistent volumes, or executing cluster-wide operations. Provisioning instances involves creating and configuring virtual machines or containers to run applications. For example, provisioning an instance might include setting up a new virtual machine on the remote system 140, installing the necessary software, and configuring network settings. Deploying applications refers to the process of making an application available for use. For instance, deploying a web application may involve transferring the application code to a server, configuring the server environment, and starting the application so that users can access the web application. Scaling application deployments involves adjusting the number of instances of an application to handle varying levels of demand. For example, if a web application experiences a sudden increase in traffic, scaling might involve adding more server instances to ensure the application remains responsive. Executing cluster-wide operations encompasses tasks that affect an entire cluster of instances, such as updating software across all instances, monitoring the health of the cluster, or managing network configurations.

The serverless pipeline framework 200 may generate execution results 202 based on executing the one or more second functions 160. Generating execution results involves collecting and processing the output data, status, and logs from each second function 160 after the second function 160 completes its respective task 134. For example, if a second function 160 is responsible for starting an instance, the execution results 202 may include the instance ID, start time, and status indicating whether the instance was successfully started. Similarly, if another second function 160 is tasked with setting the capacity of an instance, the execution results 202 may include the instance ID, the new capacity value, and a status message confirming the update. These results are then aggregated to provide a comprehensive overview of the pipeline execution, including any errors encountered and the overall success of the pipeline. Moreover, the serverless pipeline framework 200 may send the execution results 202 to the user device 10. The execution results 202, when received by the user device 10, are configured to cause the user device 10 to display the execution results 202 to the user 12 (e.g., via the GUI 15 on the screen 14 of the user device 10). The GUI 15 may present the results in an interactive format, allowing the user 12 to filter, sort, and drill down into specific details, thereby facilitating a deeper understanding of the performance of the pipeline.

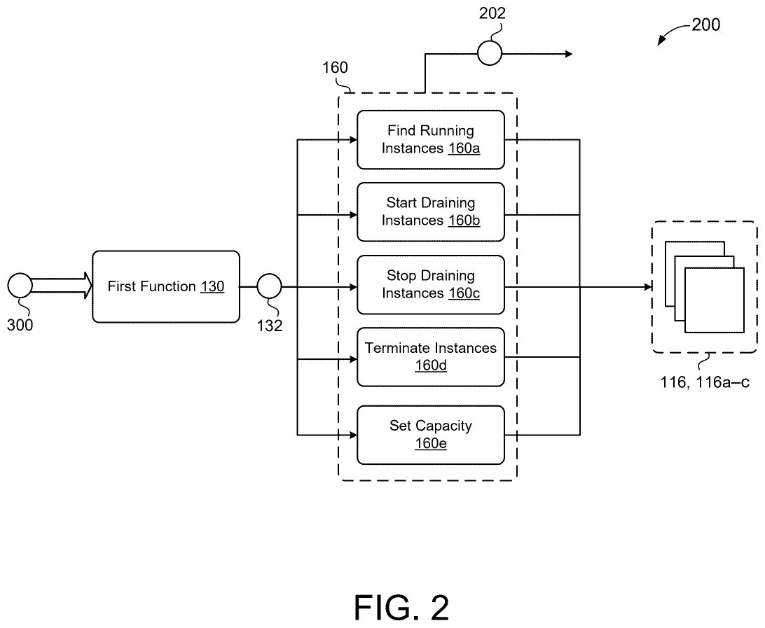

FIG. 2 illustrates an example serverless pipeline framework 200 that includes five secondary functions 160a-e to manage the allocation of computing instances among resource pools 116. Each resource pool 116 represents a group of computing instances that are assigned to a specific function or purpose, such as serving web requests, processing data, or running tests. The secondary functions 160 are serverless functions that are invoked by the first function 130 to execute tasks 134 related to the resource pools 116, according to the pipeline execution plan 132. For example, the pipeline execution plan 132 may specify that the first function 130 invokes the first secondary function 160a to find the running instances in each resource pool 116. This may involve querying the resource pool 116 to identify all active instances. Next, the first function 130 may invoke the second secondary function 160b to start draining instances from a resource pool 116 that has excess capacity. Draining instances means removing instances from the load balancer or the service registry, so that the instances stop receiving new requests or workloads but continue to handle the existing requests until completion. The pipeline execution plan 132 may also specify that the first function 130 invokes the third secondary function 160c to stop draining instances from a resource pool 116 that has insufficient capacity. This action reintroduces the instances back into the load balancer or service registry to handle new requests. Finally, the first function 130 may invoke the fourth secondary function 160d to terminate instances from a resource pool 116 that has been drained. Terminating instances means releasing the instances from the resource pool 116 and deleting the instances from the serverless computing platform.

The pipeline execution plan 132 may further specify that the first function 130 invokes the fifth secondary function 160e to set the capacity of a resource pool 116, which means adjusting the number of instances in the resource pool 116 to match the desired or optimal level. For example, if a resource pool 116 is expected to handle a high volume of web traffic during peak hours, the capacity can be increased accordingly.

Conversely, during off-peak hours, the capacity can be reduced to save costs. The secondary functions 160 use APIs to access and manipulate the resources in the resource pools 116 and return the output data and the status of the tasks 134 to the first function 130. The first function 130 monitors the execution of the tasks 134 and the secondary functions 160a-e and determines whether to proceed to the next task 134 or to terminate the pipeline execution based on the pipeline execution plan 132. In the example shown, the first function 130 obtains the pipeline configuration information 300 which represents a predefined schedule of computing instance allocation among the resource pools 116.

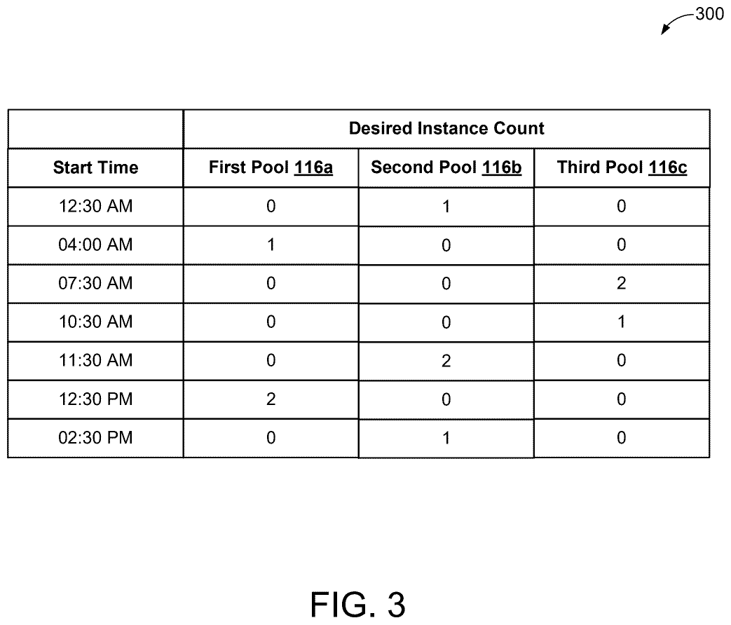

FIG. 3 illustrates example pipeline configuration information 300 representing a predefined schedule of computing instance allocation among three resource pools 116a-c. Here, the pipeline configuration information 300 is a table that specifies how many computing instances each resource pool 116 should be allocated at different times of the day. The table has four columns with the first column listing the start time of each time interval, and the other three columns list the desired instance count of each resource pool 116 at that time interval. The start times range from 12:30 AM to 2:30 PM. The desired instance count may be zero or any positive integer, depending on the expected workload and performance requirements of each resource pool 116.

In the example shown, at 4:00 AM, the pipeline configuration information 300 specifies that the serverless pipeline framework 200 should allocate one computing instance to the first resource pool 116a and release any computing instances that were previously allocated to the second resource pool 116b and the third resource pool 116c. This resource allocation may indicate that the first resource pool 116a needs to ingest data from a source that is only available at that time, while the other resource pools 116 do not have any tasks or requests to handle at that time. Alternatively, this resource allocation may indicate that the first resource pool 116a has a higher priority or a higher service level agreement than the other resource pools 116 at that time, and therefore needs more computing resources to meet demand.

Continuing with the example shown, at 11:30 AM, the pipeline configuration information 300 specifies that the serverless pipeline framework 200 should allocate two computing instances to the second resource pool 116b and release any computing instances that were previously allocated to the first resource pool 116a and the third resource pool 116c. This resource allocation may indicate that the second resource pool 116b needs to process data that has been ingested by the first resource pool 116a earlier, while the other resource pools 116 do not have any tasks or requests to handle at that time. Alternatively, this resource allocation may indicate that the second resource pool 116b has a higher priority or a higher service level agreement than the other resource pools 116 at that time. The table in FIG. 3 may include more rows and columns to represent different time intervals and different resource pools 116, as well as different desired instance counts for each resource pool 116.

Referring back to FIG. 2, based on receiving the pipeline configuration information 300 corresponding to the time of 7:30 AM in FIG. 3, the first function 130 may generate a pipeline execution plan 132 that includes a sequence of tasks 134 such that the secondary functions 160 allocate two computing instances to the third resource pool 116c and deallocate any computing instances allocated to the first resource pool 116a or the second resource pool 116b. That is, the first function 130 analyzes the pipeline configuration information 300 to determine the required changes in resource allocation. For example, if the configuration specifies that the third resource pool 116c needs two instances at 7:30 AM, the first function 130 will identify this requirement and plan the necessary steps to achieve it by generating the detailed pipeline execution plan 132, which includes a sequence of tasks 134 that need to be performed by the second functions 160. These tasks 134 may include provisioning new instances, deallocating existing instances, and updating the status of the resource pools 116. For instance, if the third resource pool 116c currently has no instances, the pipeline execution plan 132 will include tasks to provision two new instances and allocate them to the third resource pool 116c. The secondary functions 160 then execute the tasks 134 as specified in the pipeline execution plan 132. Each secondary function 160 is responsible for a specific task, such as provisioning instances or deallocating instances. For example, the first secondary function 160a may identify and provision new instances, while other secondary functions 160b-d may handle draining and terminating instances from the first resource pool 116a and second resource pool 116b. Moreover, the first function 130 monitors the execution of the tasks 134 and ensures that the resource allocation is updated as planned. If any errors occur during the execution, the first function 130 may take corrective actions, such as retrying the failed tasks or adjusting the pipeline execution plan 132. For example, if the provisioning of new instances fails, the first function 130 may retry the provisioning task or allocate instances from a different resource pool 116. In this example, the second functions 160 generate execution results 202 indicating that the third resource pool 116c has been allocated two computing instances.

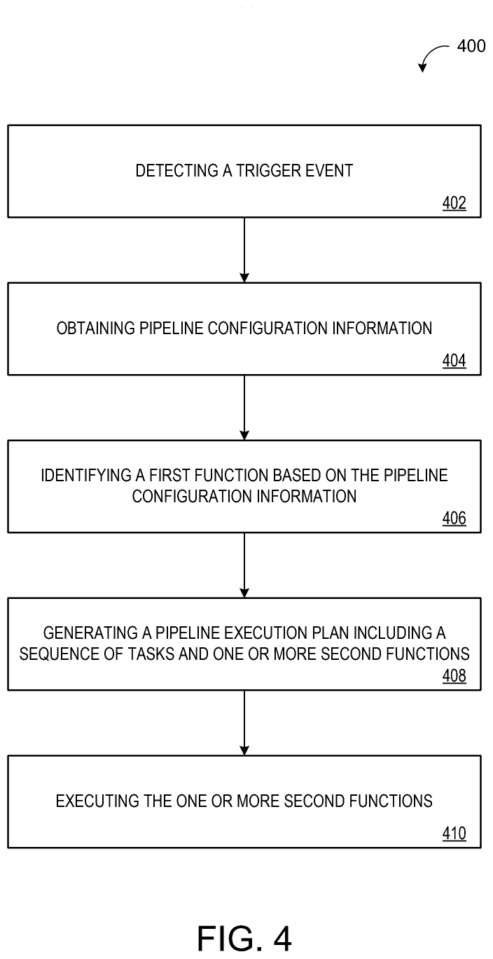

FIG. 4 is a flowchart of an exemplary arrangement of operations for a computer-implemented method 400 of using a serverless pipeline framework 200. At operation 402, the method 400 includes detecting a trigger event 114. At operation 404, the method 400 includes obtaining pipeline configuration information 300 based on detecting the trigger event 114. At operation 406, the method 400 includes identifying a first function 130 based on the pipeline configuration information 300. At operation 408, the method 400 includes generating a pipeline execution plan 132 including a sequence of tasks 134 and one or more second functions 160. Advantageously, the first function 130 and the one or more second functions 160 are serverless functions that are event-based functions that only consume resources when an event occurs. Thus, the use of serverless functions optimizes the usage of the computing resources of the remote system 140 and reduces the amount of computing resources consumed by the serverless pipeline framework 200. At operation 410, the method 400 includes executing the one or more second functions 160 based on the sequence of tasks 134.

As such, the serverless pipeline framework 200 automates various stages of building, testing, and deploying applications using serverless computing services. As discussed above, serverless computing services are cloud-based services that provide on-demand and scalable execution of code or functions based on events or requests, and charge only for actual execution time and resources used. Unlike traditional server functions, which require dedicated servers to be running continuously, serverless functions are event-driven and only run in response to specific triggers. This means that serverless functions do not incur costs or consume computing resources when they are not running, whereas server functions require ongoing maintenance and incur costs and consume computing resources even when idle. A monolithic infrastructure has several drawbacks, such as being cumbersome and inflexible, requiring significant manual configuration and maintenance, and being unable to adapt to the dynamic and diverse needs of modern software development. For example, a monolithic infrastructure may not be able to handle sudden spikes or drops in the demand for pipeline resources, may not be able to support different types of pipeline tasks or environments, and may not be able to provide high availability and fault tolerance. To address these issues, the serverless pipeline framework 200 provides a flexible, scalable, and efficient framework that does not rely on a monolithic infrastructure, but instead uses a distributed and decentralized architecture that leverages serverless computing.

Moreover, the serverless pipeline framework 200 uses a first function 130 to orchestrate the execution of the pipeline or part of the pipeline, and one or more second functions 160 to perform the tasks 134 in the pipeline. The first function 130 is a serverless function that is responsible for detecting a trigger event 114, obtaining pipeline configuration information 300, generating a pipeline execution plan 132, and invoking the second functions 160. The second functions 160 are also serverless functions that are responsible for executing the tasks 134 in the pipeline, such as provisioning instances, deploying applications, scaling application deployments, managing persistent volumes, or executing cluster-wide operations. The first function 130 and the second functions 160 communicate with each other and with other services or resources via application programming interfaces.

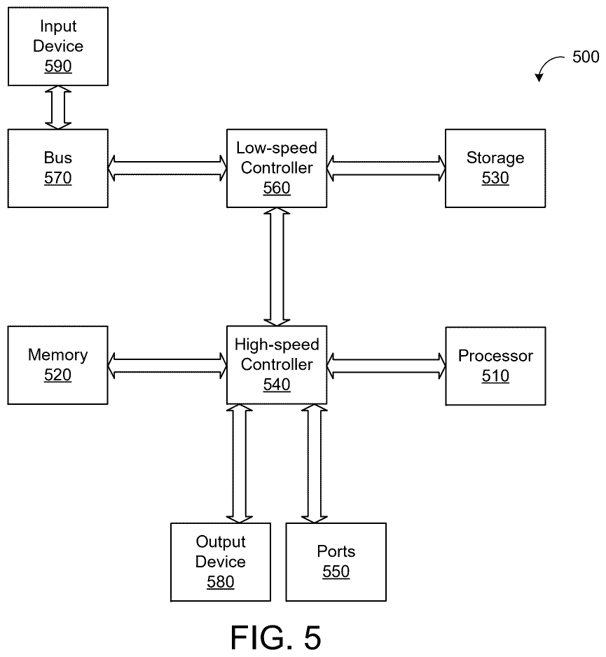

FIG. 5 is a schematic view of an example computing device 500 that may be used to implement the systems and methods described in this document. The computing device 500 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can execute instructions for performing operations within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server cluster, a group of blade servers, or a multi-processor system).

The memory 520 stores information within the computing device 500. The memory 520 may be a non-transitory computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 530 is capable of providing mass storage for the computing device 500. In some implementations, the storage device 530 is a non-transitory computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port or input device 590. The low-speed expansion port 590, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more implementations of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
detecting a trigger event;
based on detecting the trigger event, obtaining pipeline configuration information;
identifying a first function based on the pipeline configuration information;
based on the first function, generating a pipeline execution plan comprising a sequence of tasks and one or more second functions; and
executing the one or more second functions based on the sequence of tasks.

2. The method of claim 1, wherein the pipeline configuration information comprises at least one of:
pipeline task definitions;
input parameters;
sequence execution order; or
result reporting preferences.

3. The method of claim 1, wherein executing the one or more second functions comprises at least one of:
provisioning instances;
deploying applications;
scaling application deployments;
managing persistent volumes; or
executing cluster-wide operations.

4. The method of claim 1, further comprising generating execution results based on executing the one or more second functions.

5. The method of claim 4, further comprising sending the execution results to a user device, wherein the execution results, when received by the user device, are configured to cause the user device to display the execution results.

6. The method of claim 1, wherein the first function comprises a code script that executes at a distributed computing system.

7. The method of claim 1, wherein each second function comprises a respective code script that executes at a distributed computing system.

8. The method of claim 1, wherein obtaining the pipeline configuration information comprises obtaining the pipeline configuration information from a remote computing instance in communication with a distributed computing system.

9. The method of claim 8, wherein generating the pipeline execution plan comprises authenticating the remote computing instance.

10. The method of claim 1, wherein executing the one or more second functions comprises executing two or more second functions in parallel.

11. The method of claim 1, wherein executing the one or more second functions comprises:
executing an initial second function;
determining that the initial second function has completed execution; and
based on determining that the initial second function has completed execution, executing a subsequent second function.

12. The method of claim 1, further comprising, for each respective task of the sequence of tasks, selecting a respective second function of the one or more second functions, wherein executing the one or more second functions comprises executing the respective second function of the one or more second functions for the respective task.

13. A system comprising:
data processing hardware; and
memory hardware in communication with the data processing hardware, the memory hardware storing instructions that when executed on the data processing hardware cause the data processing hardware to perform operations comprising:
detecting a trigger event;
based on detecting the trigger event, obtaining pipeline configuration information;
identifying a first function based on the pipeline configuration information;
based on the first function, generating a pipeline execution plan comprising a sequence of tasks and one or more second functions; and
executing the one or more second functions based on the sequence of tasks.

14. The system of claim 13, wherein the pipeline configuration information comprises at least one of:
pipeline task definitions;
input parameters;
sequence execution order; or
result reporting preferences.

15. The system of claim 13, wherein executing the one or more second functions comprises at least one of:
provisioning instances;
deploying applications;
scaling application deployments;
managing persistent volumes; or
executing cluster-wide operations.

16. The system of claim 13, further comprising generating execution results based on executing the one or more second functions.

17. The system of claim 16, further comprising sending the execution results to a user device, wherein the execution results, when received by the user device, are configured to cause the user device to display the execution results.

18. The system of claim 13, wherein the first function comprises a code script that executes at a distributed computing system.

19. The system of claim 13, wherein each second function comprises a respective code script that executes at a distributed computing system.

20. A computer-readable medium having instructions that, when executed by data processing hardware, causes the data processing hardware to perform operations comprising:
detecting a trigger event;
based on detecting the trigger event, obtaining pipeline configuration information;
identifying a first function based on the pipeline configuration information;
based on the first function, generating a pipeline execution plan comprising a sequence of tasks and one or more second functions; and
executing the one or more second functions based on the sequence of tasks.
